(19) United States
(12) Patent Application Publication
(10) Pub. No.: US 2020/0023872 A1
(43) Pub. Date: Jan. 23, 2020

(54) Welding Cart

(71) Applicant: Matthew McCrillis, Rockford, IL (US)

(72) Inventor: Matthew McCrillis, Rockford, IL (US)

(21) Appl. No.: 16/042,007

(22) Filed: Jul. 23, 2018

(51) Int. Cl. B62B 1/20; B62B 1/00; B62B 1/26; B62B 1/22; B62B 5/06; B23K 7/10

(52) U.S. Cl. CPC B62B 1/20; B62B 1/008; B62B 1/26; B62B 2202/48; B62B 1/264; B62B 5/067; B23K 7/10; B62B 1/22

(57) ABSTRACT

Embodiments of a cart for transporting equipment are provided. The cart includes a support, a frame, and legs. The support is configured to hold the equipment. The legs are connected to the support via a first hinge joint. The legs rotate about the first hinge joint between a first leg position and a second leg position. The support is connected to the frame via a second hinge joint. The support rotates about the second hinge joint between a first support position and a second support position. The cart has a first configuration in which the at least one leg is in the first leg position and the support is in the first support position. The cart also has a second configuration in which the at least one leg is in the second leg position and the support is in the second support position.

### FIELD OF THE INVENTION

This invention generally relates to portable support systems and more particularly to a cart for transporting metal joining and cutting equipment.

### BACKGROUND OF THE INVENTION

Metal joining and cutting typically involves the use of a machine, such as a stick welder, MIG welder, TIG welder, or plasma cutter, which may weigh several tens of pounds. Further, some welding and cutting techniques require the use of a protective gas or a cutting gas, which are typically stored in tanks that also may weigh several tens of pounds. Additionally, the welding/cutting machine may have various cords, such as the cord between the machine and the welding tool, a power cord, and a cord for the grounding clamp that is attached to a workpiece. Still further, a hose is typically provided between the gas tank and the welding/cutting machine to transport the welding/cutting gas between the tank and the welding/cutting machine. The welding or cutting process generally also requires electrodes, wire, pliers, brushes, and so on.

Transporting all of this equipment, even around one's own shop, can be cumbersome not only because of the combined weight of all the equipment but also because of the difficulty in managing, e.g., dangling cords, small tools, and other various welding/cutting accessories. Various carts designed to transport welding/cutting equipment are known, but many take up a large amount of space when not being used. Further, some carts elevate the welding/cutting machine so as to improve visibility of the various dials and setting knobs, but during transportation, the carts are top heavy and may be prone to tipping. Other carts that place the welding/cutting machine lower provide a lower center of gravity during transportation but are consequently more difficult to see for adjusting of welding settings. A cart that addresses these shortcomings of conventional welding carts would be beneficial.

Embodiments of the present invention provide such a cart that allows for ease of transportation and adjustment during operation and a smaller footprint during storage. These and other advantages of the invention, as well as additional inventive features, will be apparent from the description of the invention provided herein.

### BRIEF SUMMARY OF THE INVENTION

In one aspect, embodiments of the present disclosure relate to a cart for transporting equipment for metal joining and/or cutting. The cart includes a support, a frame, and at least one leg. The support is configured to hold the equipment, and the support has a first support end and a second support end. The at least one leg is connected proximate to the first support end via a first hinge joint. The at least one leg rotates about the first hinge joint between a first leg position in which the at least one leg forms a first leg angle with the support and a second leg position in which the at least one leg forms a second leg angle with the support. The second leg angle is greater than the first leg angle. The second support end of the support is connected to the frame via a second hinge joint. The support rotates about the second hinge joint between a first support position in which the support forms a first support angle with the frame and a second support position in which the support forms a second support angle with the frame. The second support angle is greater than the first support angle. The cart has a first configuration in which the at least one leg is in the first leg position and the support is in the first support position. The cart also has a second configuration in which the at least one leg is in the second leg position and the support is in the second support position.

In one aspect, embodiments of the present disclosure relate to a cart. The cart includes a support having a first support end and a second support end. The cart also includes a frame having a first side member, a second side member, a cross member, and a base member. The first side member and the second side member define a first width of the frame that is wider than the support, and the cross member and the base member are disposed at opposite ends of the frame. The cart includes two wheels carried on an axle. The axle is spatially disposed from the base member, and the two wheels are disposed outside of the first side member and the second side member. The cart includes two legs connected proximate to the first support end via a first hinge joint. The two legs rotate about the first hinge joint between a first leg position in which the two legs form a first leg angle with the support and a second leg position in which the two legs form a second leg angle with the support. The second leg angle is greater than the first leg angle. The cart also includes a back plate joined at one end to the axle and having at least one caster wheel mounted to a surface and at least one peg extending from the second support end. The second support end of the support is connected to the frame via a second hinge joint. The support rotates about the second hinge joint between a first support position in which the support forms a first support angle with the frame and a second support position in which the support forms a second support angle with the frame. The second support angle is greater than the first support angle. The cart has a first configuration in which the two legs are in the first leg position and the support is in the first support position. In the first configuration, the cart has a horizontal position in which the cart is supported on the two wheels and the at least one caster wheel and a vertical position in which the cart is supported on the two wheels and the at least one peg. Further, the cart has a second configuration in which the two legs are in the second leg position and the support is in the second support position and in which the cart is supported on the two legs and the two wheels.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a side view of a cart for metal joining and/or cutting equipment in a deployed configuration, according to an exemplary embodiment;

FIG. 2 is a front view of the cart shown in FIG. 1;

FIG. 3 is a side view of another embodiment of a cart for metal joining and/or cutting equipment in a collapsed configuration, according to an exemplary embodiment;

FIG. 4 is a close-up view of the front of the cart of FIG. 3;

FIG. 5 is a view of an extendable handle of the cart of FIG. 3;

FIG. 6 depicts the cart of FIG. 3 in a vertical collapsed configuration; and

FIG. 7 depicts the cart of FIG. 3 in a deployed configuration with legs extended.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

Various embodiments of a cart for transporting metal joining and cutting tools, such as welders, plasma cutters, and welding/cutting gas, are provided herein. The cart is configurable to transition between a first configuration, or a deployed configuration, in which a support surface extends outwardly from a frame and a second configuration, or collapsed configuration, in which the support surface is folded towards the frame. The cart includes legs and wheels that provide stability to the cart in the deployed configuration, while still allowing for movement within a workspace. Further, in the collapsed configuration, the cart includes elements that allow for convenient pulling of the cart in either a vertical position or in a horizontal position. These and other aspects of the cart will be described more fully below with reference to the figures. Further, the embodiments described herein are presented by way of illustration and are not intended to limit the scope of the disclosure.

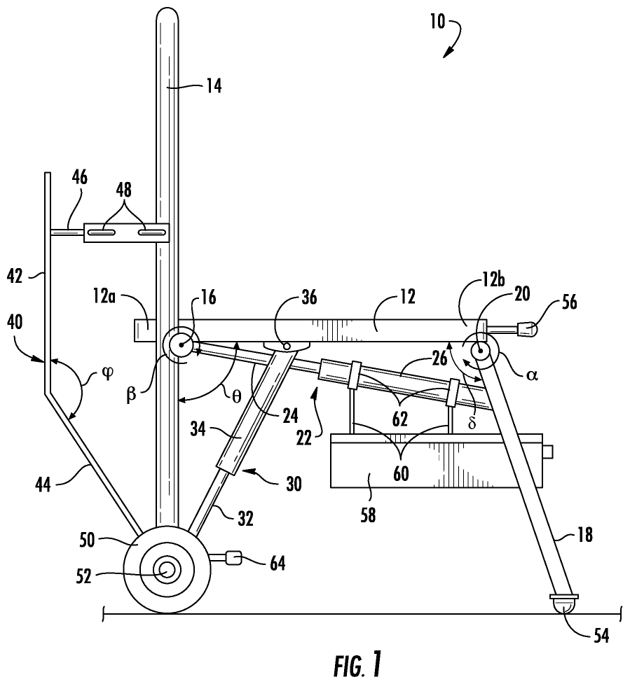

Referring to FIG. 1, an embodiment of a cart 10 in a first, deployed configuration is provided. The cart 10 includes a support 12 that, in the deployed configuration, extends at an angle θ of at least 85° relative to a frame 14. In embodiments, the support 12 extends at an angle θ of about 90° relative to the frame 14 in order to provide a flat surface for equipment in the deployed configuration. In still another embodiment, the support 12 extends at an angle θ of about 95° to 110° relative to the frame 14 in the deployed configuration so as to angle equipment sitting thereon upward to enhance the visibility of any control dials, knobs, switches, etc. that may be present on the face of the equipment. As will be discussed more fully below, in the collapsed configuration, the support angle θ between the frame 14 and the support 12 is less than the support angle θ between the frame 14 and the support 12 in the deployed configuration. The support 12 is rotatably connected to the frame 14 via a first hinge joint 16. In particular, the support 12 has a first end 12a and a second end 12b, and the connection to the frame 14 is provided proximate to the first end 12a.

At the send end 12b, at least one leg 18 is rotatably connected to the support 12 via a second hinge joint 20. In the embodiments depicted throughout the figures and discussed herein, the cart 10 has two legs 18, but from the side view shown in FIG. 1, only one leg 18 can be seen. However, in embodiments, the cart 10 could have one leg 18, two legs 18, or more. The legs 18 form a leg angle δ with the support 12. In the deployed configuration as shown in FIG. 1, the leg angle δ is at least 90° in embodiments. In other embodiments, the leg angle δ is at least 100°. As will be discussed more fully below, in the collapsed configuration, the leg angle δ between the legs 18 and the support 12 is less than the leg angle δ between the legs 18 and the support 12 in the deployed configuration.

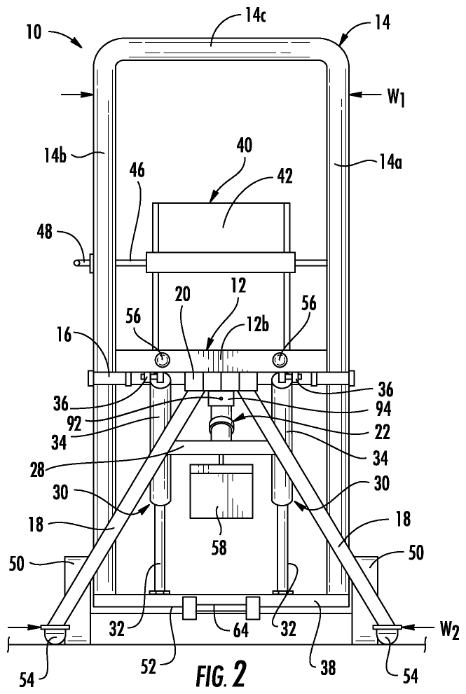

The first hinge joint 16 and the second hinge joint 20 allow the cart 10 to collapse into a travel or storage configuration. In this regard, the second hinge joint 20 allows the legs 18 to be folded under the support 12 by rotating the legs 18 about axis α, which is defined by the second hinge joint 20. Once the legs 18 are folded under the support 12, the support 12 is rotated about axis β, which is defined by the first hinge joint 16. In embodiments, rotation of the legs 18 is facilitated by a leg extension cylinder 22 that includes a first piston arm 24 and a first cylinder 26. The first piston arm 24 is configured to extend from and retract into the first cylinder 26. The first piston arm 24 is connected to the first hinge joint 16, and the first cylinder 26 is connected to a bar 28 (shown in FIG. 2) between the legs 18. When folding the legs 18 under the support 12, the leg extension cylinder 22 decreases in length (i.e., the first piston arm 24 is forced or retracted into the first cylinder 26) and moves upwardly toward the support 12. In moving upwardly, the piston arm 24 of the leg extension cylinder 22 rotates about the first hinge joint 16.

Upon folding the legs 18 under the support 12, the support 12 can be rotated about axis β. In embodiments, rotation of support 12 is facilitated by at least one support extension cylinder 30. In the embodiments depicted throughout the figures and discussed herein, the cart 10 has two support extension cylinders 30, but from the side view shown in FIG. 1, only one support extension cylinder 30 can be seen. The support extension cylinder 30 includes a second piston arm 32 and a second cylinder 34 in which the second piston arm 32 is configured to extend from and retract into the second cylinder 34. The second cylinder 34 is connected to the underside of the support 12 via a pivot joint 36. The second piston arm 32 is connected to a base member 38 of the frame 14 (as shown in FIG. 2). In this way, when the support 12 is folded about axis β, the support extension cylinder 30 shortens (i.e., the second piston arm 32 is forced or retracted into the second cylinder 34), and the support extension cylinder 30 pivots about the pivot joint 36.

As can also be seen in FIG. 1, the cart 10 also includes a back plate 40 to which a tank for welding and/or cutting gas is secured. As depicted in FIG. 1, the back plate 40 is includes a first section 42 and a second section 44 that define an angle φ. A hoop 46 is provided to contain the tank and to connect the back plate 40 to the frame 14. In embodiments, winding prongs 48 are provided on the hoop 46 to provide a place to wind a cord or hose of the equipment.

In the deployed configuration shown in FIG. 1, the cart 10 is movable via wheels 50. In the embodiments depicted throughout the figures and discussed herein, the cart 10 has two wheels 50, but from the side view shown in FIG. 1, only one wheel 50 can be seen. The wheels 50 are connected to ends of an axle 52. In embodiments, the axle 52 is spatially disposed from the base member 38 of the frame 14 (as shown in FIG. 2). In other embodiments, the axle 52 is the base 38 member of the frame 14. Additionally, the back plate 40 is connected to the axle 52 via welding. In the deployed configuration, movement of the cart 10 can also be facilitated in embodiments by use of mobile elements, such as casters, roller balls, wheels, etc. on the legs 18. As depicted in FIG. 1, the legs 18 are provided with the mobile elements of roller balls 54 to facilitate movement in the deployed configuration. When the cart 10 is in the collapsed configuration (i.e., legs 18 folded under the support 12 and the support 12 folded downward), the wheels 50 allow the cart 10 to be transported similar to a hand truck.

When in the collapsed configuration, the cart 10 is able to stand without being supported by a user via at least one peg 56 projecting outwardly from the second end 12b of the support 12. In the embodiments depicted throughout the figures and discussed herein, the cart 10 has two pegs 56, but from the side view shown in FIG. 1, only peg 56 can be seen. The pegs 56 extend in the same plane as defined by the support 12. As mentioned, in the collapsed configuration, the support 12 is rotated downward such that second end 12b points toward the ground. In this way, the cart 10 is able to balance on the wheels 50 and the pegs 56.

Another feature that can be seen in FIG. 1 is a storage container 58 that hangs from the leg extension cylinder 22. In particular, the storage container 58 is connected to the leg extension cylinder 22 via a rod 60 and a ring 62. In the embodiment shown in FIG. 1, the storage container 58 is connected to the leg extension cylinder 22 using two rods 60 and rings 62. As can be seen, the rings 62 are mounted around the first cylinder 26 of the leg extension cylinder 22. The rings 62 can be held in place using an adhesive or other bonding agent, welding, fasteners, pins, etc., or the rings 62 can be allowed to travel on the first cylinder 26. The rods 60 are connected to the rings 62 at one end and to the storage container 58 at their other end. Because the storage container 58 is connect to the leg extension cylinder 22, the storage container moves with the leg extension cylinder 22 and legs 18 when the legs 18 are folded or deployed. In particular, in the collapsed configuration the storage container 58 retracts toward the frame 14 and upwardly toward the support 12 because the leg extension cylinder 22 shrinks. Conversely, when the legs 18 are deployed in the deployed configuration as shown in FIG. 1, the leg extension cylinder 22 is extended, which brings the storage container 58 forward for easier access. The storage container 58 may have a drawer that pulls out, a lid that lifts off, or any other closure mechanism by which access to the interior of the storage container 58 is provided.

FIG. 2 depicts a front view of the cart 10. As can be seen better from the front view, the frame 14 generally has an inverted U-shape with a first side member 14a, a second side member 14b, and a cross member 14c. The first side member 14a and the second side member 14b define a first width Wi of the frame 14. The first side member 14a and the second side member 14b are joined to the base member 38, e.g., by welding. In an embodiment, a handle 64 extends from the base member 38. As will be discussed more fully below, the handle 64 facilitates lifting the front end of the cart 10 when in the collapsed configuration and, in embodiments, provides a locking mechanism to maintain the cart in the collapsed configuration.

As can also be seen in FIG. 2, the legs 18 of the cart 10 are angled outwardly in an embodiment. That is, in an embodiment, the legs 18 do not extend directly downward from the support 12 to the ground but instead are splayed outwardly, which provides additional stability for the cart 10. In embodiments, the legs 18 are angled outwardly so as to define a second width W₂ at the ends of the legs 18. In embodiments, the second width W₂ of the legs 18 is greater than the first width W₁ of the frame 14. Thus, when folded under the support 12, the legs 18 are positioned outside the first side member 14a and the second side member 14b.

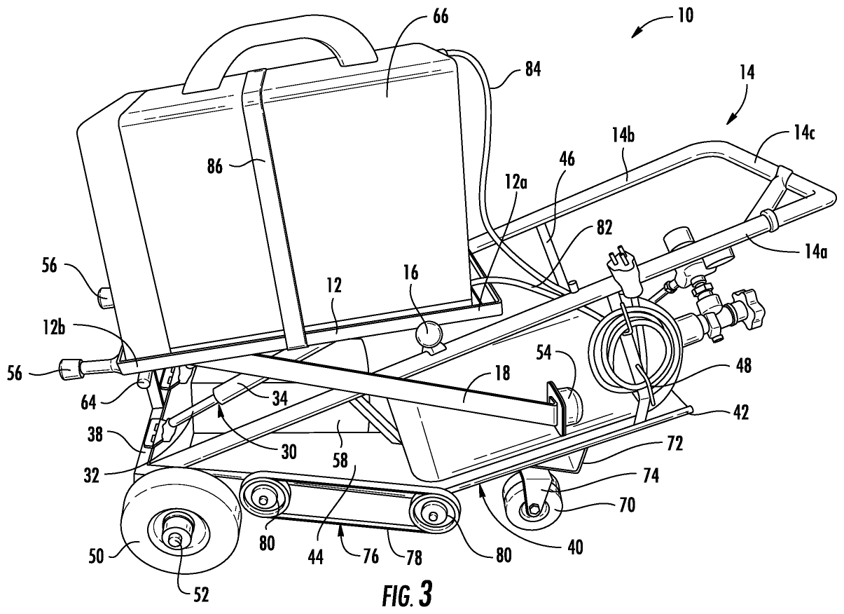

FIG. 3 depicts another embodiment of a cart 10 that is substantially similar to the cart 10 depicted in FIGS. 1-2, and thus, like numerals refer to like structures. As compared to FIG. 3, the embodiment of the cart 10 shown in FIGS. 1-2 is somewhat simplified, and the embodiment of the cart 10 in FIG. 3 contains additional features and is shown with the welding/cutting equipment contained thereon.

In the embodiment depicted in FIG. 3, equipment 66 is contained on the support 12 of the cart 10. Particularly, the equipment 66 is a MIG welder that is provided with a tank 68 of inert gas (generally, argon or a mixture of argon and carbon dioxide). As can be seen, in the collapsed configuration, the cart 10 is arranged such that the frame 14 is tilted backwardly such that the frame 14 is closer to horizontal as compared to closer to vertical in the deployed configuration. As can be seen in FIG. 3, the support angle θ in the collapsed configuration is much less than the support angle θ in the deployed configuration as shown in FIG. 1. In embodiments, the support angle θ between the frame 14 and the support 12 is 45° or less in the collapsed configuration, and in other embodiments, the support angle θ between the frame 14 and the support 12 is 30° or less in the collapsed configuration. Similarly, the leg angle δ in the collapsed configuration is much less than the leg angle δ in the deployed configuration as shown in FIG. 1. In embodiments, the leg angle δ between the legs 18 and the support 12 is 10° or less in the collapsed configuration, and in other embodiments, the leg angle δ between the legs 18 and the support 12 is 5° or less in the collapsed configuration.

Further, in the collapsed configuration, the back plate 40 is arranged such that the second section 44 is substantially parallel with the ground. Additionally, in the embodiment depicted in FIG. 3, the first section 42 of the back plate 40 has caster wheels 70 affixed thereto via a mounting bracket 72 and wheel bracket 74. In particular, the mounting bracket 72 is affixed to the first section 42, e.g., by welding, and the wheel bracket 74 connected to the mounting bracket 72 in such a way as to allow the caster wheels 70 to swivel relative to the mounting bracket 72. Thus, in the embodiment of FIG. 3, the cart 10 is able to be supported on the wheels 50 and the caster wheels 70 when in the collapsed configuration.

Additionally, in embodiments, the second section 44 of the back plate 40 includes a track assembly 76 along both sides (although, only a single track assembly 76 can be seen from the view in FIG. 3). The track assembly 76 includes a belt 78 carried on pulley wheels 80. The track assembly 76 moving the cart 10 up stairs or over ledges, curbs, or other stepped surfaces.

As can be seen in FIG. 3, the cart 10 is able to secure the equipment 66 and the tank 68 in a compact and orderly manner. As can be seen, the equipment has a power cord 82 extending from the rear of the equipment. The power cord 82 is wound around the winding prongs 48 proximate to the first side member 14a of the frame, to keep the power cord 82 from tangling, dragging on the ground, and/or getting caught in the wheels 50 or caster wheels 70. Further, in embodiments, the cart 10 contains another set of winding prongs 48, e.g., proximate to the second side member 14b of the frame 14, to organize a gas hose 84 between the equipment 66 and the tank 68. Additionally, in the embodiment shown in FIG. 3, the equipment 66 is secured to the support 12 using a strap 86. In embodiments, the strap 86 is able to be tightened, using a variety of strap adjusters, ratchets, clamps, buckles, etc.

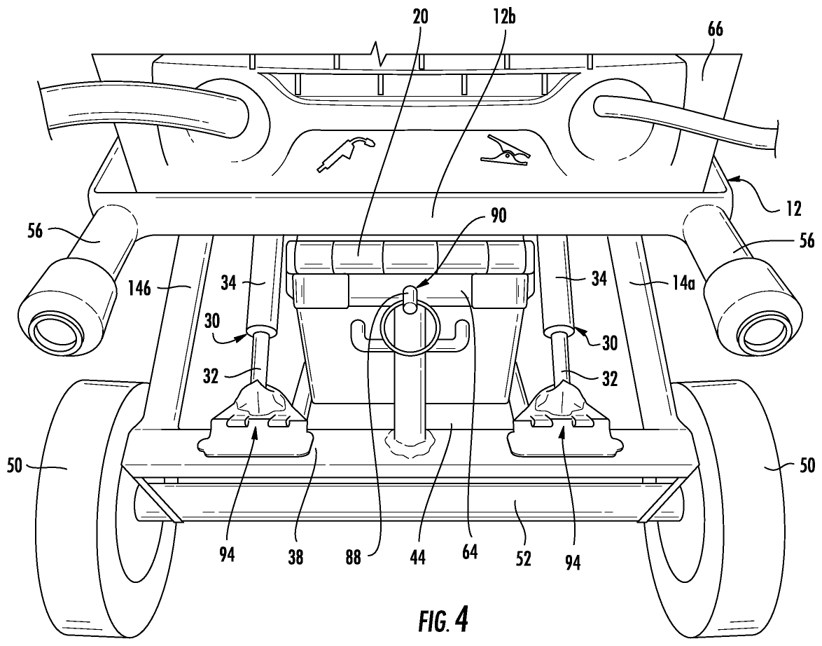

FIG. 4 depicts a more detailed view of the cart 10 as viewed from the second end 12b of the support 12 in the collapsed configuration. As can be seen in FIG. 4, the handle 64 extending from the base member 38 includes a locking pin 88 that is inserted through a first pinhole 90 in the handle 64. The locking pin 88 engages a second pinhole 92 on a tab 94 (both shown in FIG. 2) extending below the second hinge joint 20. When the locking pin 88 is inserted through pinholes 90, 92, the base member 38 is locked in position relative to the support 12 such that the support 12 cannot unfold from the frame 14.

FIG. 4 also depicts the connection between the support extension cylinders 30 and the base member 38. The piston arms 34 of the support extension cylinders 30 are connected to the base member 38 via hinges 94, which allow the support extension cylinders 30 to rotate during extension and retraction while the support 12 is unfolded and folded.

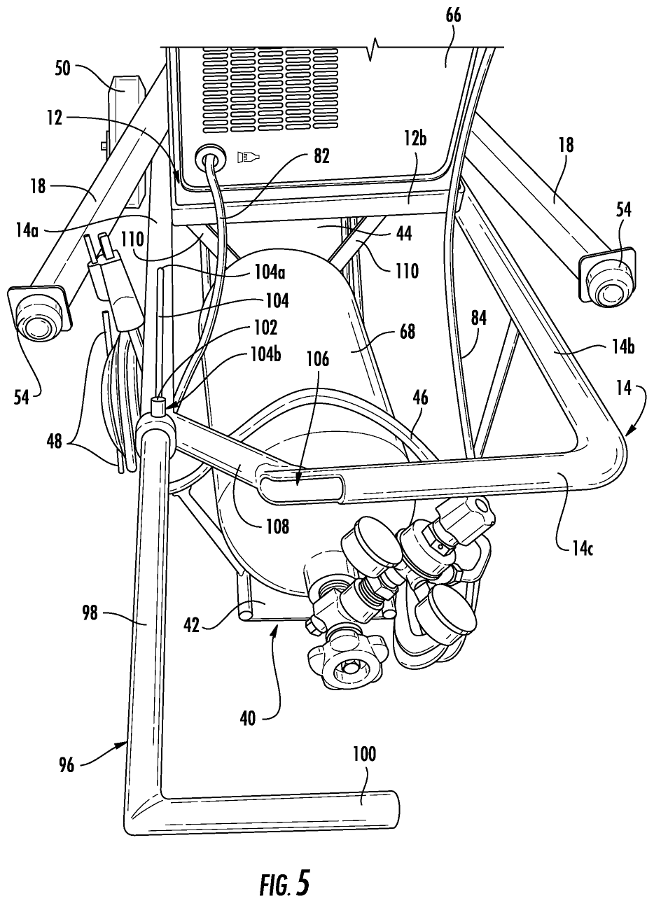

FIG. 5 depicts a view of the cart 10 as seen from the first end 12a of the cart 10. In FIG. 5, it can be seen that, in embodiments, the frame 14 is provided with an extensible handle 96. The extensible handle 96 includes a first handle portion 98 and a second handle portion 100, and in the embodiment depicted in FIG. 5, the first handle portion 98 and the second handle portion 100 are arranged substantially perpendicularly to each other. The first handle portion 98 of the extensible handle 96 slides within the first side member 14a of the frame 14. At an end of the first handle portion 98 is a nut 102 that slides within a slot 104 formed in the first side member 14a. In a retracted potion of the extensible handle 96, the nut 102 is located at a first end 104a of the slot 104, and in an extended position, the nut 102 is located at a second end 104b of the slot 104. The nut 102 and slot 104 prevent the extensible handle 96 from being pulled out of the first side member 14a. As can be seen in FIG. 5, the extensible handle 96 is in the extended position. In the retracted position, the second handle portion 100 fits into a recess 106 of the cross member 14c of the frame 14. Thus, in the retracted position, the extensible handle 96 allows the contour of the corner defined by the first side member 14a and the cross member 14c to substantially mirror the contour of the corner defined by the second side member 14b and the cross member 14c. In FIG. 5, it can be seen that, in embodiments, a brace 108 is provided to connect the first side member 14a and the cross member 14c in the region where the extensible handle 96 extends from the frame 14.

In FIG. 5, two support arms 110 can also be seen. These support arms 110 extend from the first side member 14a and the second side member 14b, respectively, to the back plate 40, in particular, to the region of the angle φ (as shown in FIG. 1). The support arms 110 define a support surface upon which the tank 68 rests when inserted into the hoop 46. In embodiments, the ends of the support arms 110 are connected to each other in the region under the tank 68. In other embodiments, the ends of the support arms 110 are connected to the back plate 40 in the region under the tank 68. In still other embodiments, the support arms 110 are not connected to either the each other or the back plate and instead are cantilevered from their respective side members 14a, 14b.

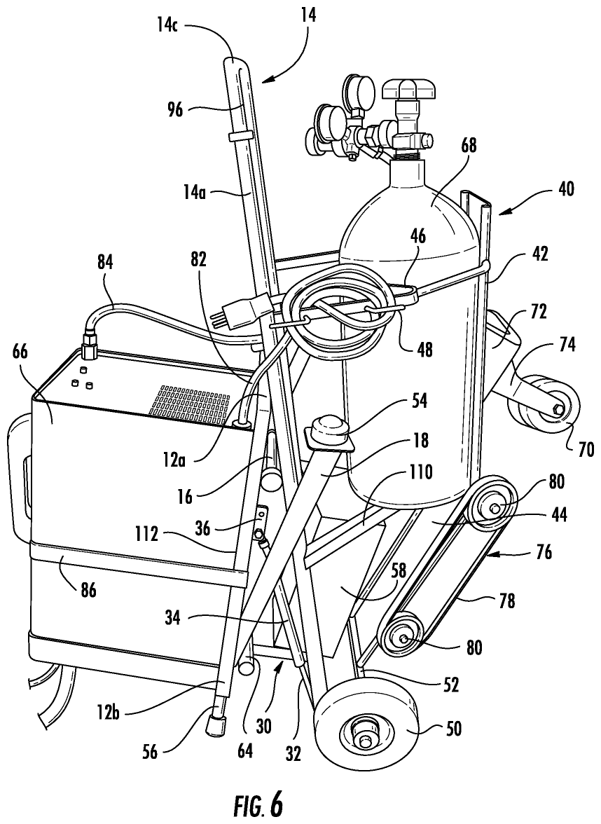

As mentioned above, the cart 10 in the collapsed configuration can be placed into a vertical position, which is shown in FIG. 6. As can be seen, in the deployed configuration, the cart 10 is stabilized on the wheels 50 and the pegs 56. The strap 86 keeps the equipment 66 secured to the support 12 even though the support 12 is in a substantially vertical position. In this regard, the support 12 is, in embodiments, provided with a peripheral lip 112 that prevents the equipment 66 from sliding off of the support 12 when the in the vertical position.

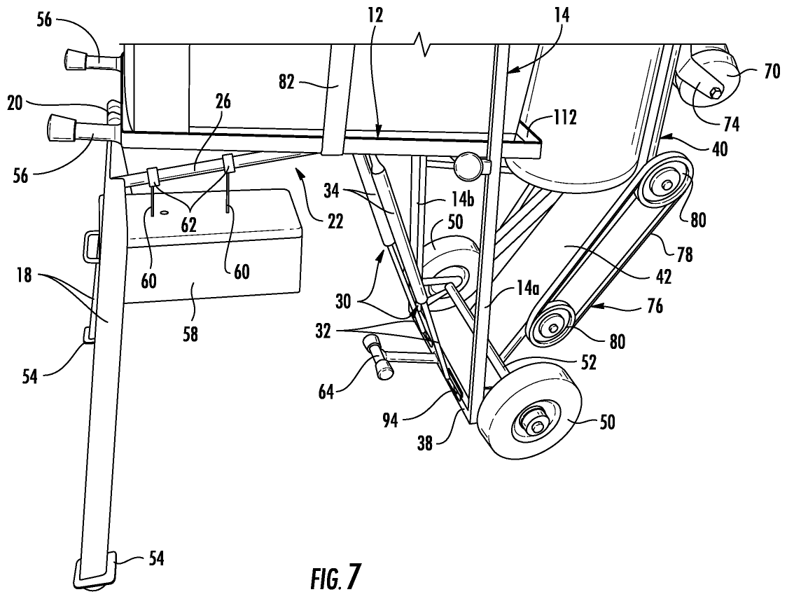

Referring now to FIG. 7, the cart 10 is shown in the deployed configuration so as to demonstrate the position of the equipment 66 and tank 68 in the deployed configuration. As can be seen, the equipment 66 is secured to the support 12 via the strap 86 and contained within the boundaries defined by the peripheral lip 112. The support 12 is also angled slightly upward relative to the frame 14 as described above to provide for enhanced visibility of the face of the equipment 66. Further, the tank 68 is supported on the support arms 110 and provided in an upright configuration, which may facilitate distribution of the welding/cutting gas depending on the type of gas being used. Additionally, with the cart 10 being supported by the roller balls 54 and the wheels 50, the cart 10 can be moved around the workspace without having to collapse the cart 10 into a collapsed configuration.

FIGS. 1-7 depict a cart 10 suitable for transporting welding and/or cutting equipment 66, including a tank 68 of welding/cutting gas. The cart 10 has a collapsed configuration in which the legs 18 are folded under the support 12 and in which the support 12 is folded towards the frame 14. In the collapsed configuration, the cart 10 has a vertical position in which the cart 10 can be pulled like a hand truck and balances on pegs 56 located at the second end 12b of the support 12. Further, in the collapsed configuration, the cart 10 has a horizontal position in which the cart 10 is able to be moved via wheels 50 and caster wheels 70 on the back plate 40. The extensible handle 96 facilitates dragging the cart 10 in the horizontal position. The cart 10 also has a deployed configuration, which is generally the configuration that the cart 10 is in when performing a welding/cutting operation. By providing a cart 10 that transitions between the deployed configuration and the collapsed configuration, welding/cutting equipment 66 can be transported more efficiently and in a manner that reduces storage space. Further, in embodiments, the cart 10 includes several elements that provide organized storage of welding tools, cords, and other accessories.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A cart for transporting equipment for metal joining and/or cutting, the cart comprising:
a support configured to hold the equipment, the support having a first support end and a second support end;
a frame;
at least one leg connected proximate to the first support end via a first hinge joint, the at least one leg rotating about the first hinge joint between a first leg position in which the at least one leg forms a first leg angle with the support and a second leg position in which the at least one leg forms a second leg angle with the support, the second leg angle being greater than the first leg angle;
wherein the second support end of the support is connected to the frame via a second hinge joint, the support rotating about the second hinge joint between a first support position in which the support forms a first support angle with the frame and a second support position in which the support forms a second support angle with the frame, the second support angle being greater than the first support angle;
wherein the cart has a first configuration in which the at least one leg is in the first leg position and the support is in the first support position; and
wherein the cart has a second configuration in which the at least one leg is in the second leg position and the support is in the second support position.

2. The cart of claim 1, wherein the second support angle is at least 85°.

3. The cart of claim 1, further comprising a leg extension cylinder having a first end connected to the second hinge joint and having a second end connected to the at least one leg, wherein the leg extension cylinder has a first length in the first leg position and a second length in the second leg position, the second length being greater than the first length.

4. The cart of claim 3, further comprising a storage container, the storage container being carried by the leg extension cylinder.

5. The cart of claim 1, wherein each of the at least one leg comprises a mobile element located at an end of the leg distal from the first hinge joint

6. The cart of claim 1, further comprising at least one support extension cylinder, each of the at least one support extension cylinder having a first end connected to the frame and having a second end connected to the support, wherein each of the at least one support extension cylinder has a first length in the first support position and a second length in the second support position, the second length being greater than the first length.

7. The cart of claim 1, further comprising a back plate, the back plate comprising a first section, a second section, and a hoop connected to the first section, wherein the first section and the second section are arranged at an obtuse angle, and wherein the back plate is configured to receive a tank of welding or cutting gas through the hoop and into a space between the back plate and the frame.

8. The cart of claim 7, further comprising at least one caster wheel mounted to the first section of the back plate.

9. The cart of claim 7, further comprising at least one support arm extending from the frame toward the back plate, the at least one support arm configured to support the tank.

10. The cart of claim 7, further comprising two track assemblies, wherein the two track assemblies are carried on opposite sides of the second section.

11. The cart of claim 1, further comprising at least one peg at the first end of the support, wherein, in the second configuration, the cart has a vertical position in which the cart is at least partially supported on the at least one peg.

12. The cart of claim 1, wherein the frame comprises a first side member, a second side member, a cross member, and a base member, wherein the first side member and the second side member define a first width of the frame, wherein the cross member and the base member are disposed at opposite ends of the frame.

13. The cart of claim 12, wherein the frame comprises an extensible handle that extends from and retracts into at least one of the first side member or the second side member.

14. The cart of claim 12, wherein the at least one leg comprises two legs, the two legs defining a second width between a respective end of each of the two legs, wherein the second width is greater than the first width.

15. The cart of claim 12, further comprising a handle extending from the base member.

16. The cart of claim 15, wherein the handle is configured to receive a locking pin that extends through the handle and into a tab connected to the support, wherein the cart cannot transition from the first configuration to the second configuration when the locking pin is inserted through the handle and into the tab.

17. The cart of claim 12, wherein the base member of the frame is an axle that carries two wheels disposed outside of the first base member and the second base member.

18. The cart of claim 12, further comprising an axle spatially disposed from the base member of the frame, wherein the axle carries two wheels disposed outside of the first base member and the second base member

19. The cart of claim 1, wherein the support comprises a peripheral lip.

20. The cart of claim 19, wherein the support comprises a strap configured to hold the equipment to the support.

21. A cart, comprising:
a support having a first support end and a second support end;
a frame, the frame comprising a first side member, a second side member, a cross member, and a base member, wherein the first side member and the second side member define a first width of the frame that is wider than the support, wherein the cross member and the base member are disposed at opposite ends of the frame;
two wheels carried on an axle, the axle being spatially disposed from the base member and the two wheels being disposed outside of the first side member and the second side member;
two legs connected proximate to the first support end via a first hinge joint, the two legs rotating about the first hinge joint between a first leg position in which the two legs form a first leg angle with the support and a second leg position in which the two legs form a second leg angle with the support, the second leg angle being greater than the first leg angle;
a back plate joined at one end to the axle and having at least one caster wheel mounted to a surface;
at least one peg extending from the second support end;
wherein the second support end of the support is connected to the frame via a second hinge joint, the support rotating about the second hinge joint between a first support position in which the support forms a first support angle with the frame and a second support position in which the support forms a second support angle with the frame, the second support angle being greater than the first support angle;
wherein the cart has a first configuration in which the two legs are in the first leg position and the support is in the first support position;
wherein, in the first configuration, the cart has a horizontal position in which the cart is supported on the two wheels and the at least one caster wheel and a vertical position in which the cart is supported on the two wheels and the at least one peg; and
wherein the cart has a second configuration in which the two legs are in the second leg position and the support is in the second support position and in which the cart is supported on the two legs and the two wheels.
